(19) United States
(12) Patent Application Publication
(10) Pub. No.: US 2026/0063942 A1
(43) Pub. Date: Mar. 5, 2026

(54) LIQUID CRYSTAL ELEMENT

(71) Applicant: Japan Display Inc., Tokyo (JP)

(72) Inventors: Shunichi KIMURA, Tokyo (JP); Yasuhiro TAKAHASHI, Tokyo (JP); Toshiharu MATSUSHIMA, Tokyo (JP)

(21) Appl. No.: 19/317,963

(22) Filed: Sep. 3, 2025

(30) Foreign Application Priority Data
Sep. 5, 2024 (JP) 2024-152853

(51) Int. Cl. G02F 1/1333; G02F 1/1343

(52) U.S. Cl. CPC G02F 1/133345; G02F 1/134309

(57) ABSTRACT

According to an aspect, a liquid crystal element includes: a first substrate and a second substrate facing each other; a plurality of element sets disposed on the first substrate and each including a first electrode and a second electrode; a third electrode disposed on the second substrate and overlapping the element sets in plan view; a liquid crystal layer positioned between the first substrate and the second substrate; and an insulating member having an electrical insulation property and disposed in the liquid crystal layer. In plan view, the first electrode and the second electrode in each of the element sets extend in a first direction and face each other in a second direction orthogonal to the first direction. The element sets are arranged in the second direction. The insulating member overlaps a gap between two adjacent ones of the element sets in the second direction in plan view.

### CROSS-REFERENCE TO RELATED APPLICATION

This application claims the benefit of priority from Japanese Patent Application No. 2024-152853 filed on Sep. 5, 2024, the entire contents of which are incorporated herein by reference.

### BACKGROUND

### 1. Technical Field

What is disclosed herein relates to a liquid crystal element.

### 2. Description of the Related Art

Japanese Patent Application Laid-open Publication No. 2015-174551 (JP-A-2015-174551) discloses a headlight capable of controlling light distribution. The headlight of JP-A-2015-174551 reflects light from a light source by using a mirror, converges the reflected light with a lens, and projects light toward the front side of the vehicle.

The direction of light projection is adjusted by adjusting the angle of the mirror.

Japanese Patent Application Laid-open Publication No. 2023-63255 (JP-A-2023-63255) discloses an illumination device including a lamp unit including a light source, and an arm coupled to the lamp unit. The arm includes a first arm and a second arm coupled to each other in a relatively rotatable manner. The lamp unit and the second arm are coupled to each other in a relatively rotatable manner. The emission direction of light from the light source is adjusted by adjusting the angle between the first and second arms and the angle between the lamp unit and the second arm.

In a device capable of adjusting the emission direction of light as in JP-A-2015-174551 or JP-A-2023-63255, the emission direction of light is adjusted through operation of a movable part in a mechanism including a plurality of mechanical components. The configuration of such a device is desired to be simplified.

For the foregoing reasons, there is a need for a liquid crystal element capable of easily adjusting the emission direction of light.

### SUMMARY

According to an aspect, a liquid crystal element includes: a first substrate and a second substrate facing each other; a plurality of element sets disposed on the first substrate and each including a first electrode and a second electrode; a third electrode disposed on the second substrate and overlapping the element sets in plan view; a liquid crystal layer positioned between the first substrate and the second substrate; and an insulating member having an electrical insulation property and disposed in the liquid crystal layer. In plan view, the first electrode and the second electrode in each of the element sets extend in a first direction and face each other in a second direction orthogonal to the first direction. The element sets are arranged in the second direction. The insulating member overlaps a gap between two adjacent ones of the element sets in the second direction in plan view.

According to an aspect, a liquid crystal element includes: a first substrate and a second substrate facing each other; a plurality of element sets disposed on the first substrate and each including a first electrode and a second electrode; a plurality of second element sets disposed on the second substrate and each including a fourth electrode and a fifth electrode; a liquid crystal layer positioned between the first substrate and the second substrate; and an insulating member having an electrical insulation property and disposed in the liquid crystal layer. In plan view, the first electrode and the second electrode in each of the element sets extend in a first direction and face each other in a second direction orthogonal to the first direction. In each of the second element sets, the fourth electrode extends in the first direction and overlaps the first electrode of one of the element sets in plan view, and the fifth electrode extends in the first direction and overlaps the second electrode of the one element set in plan view. The element sets and the second element sets are each arranged in the second direction. The insulating member overlaps a gap between two adjacent ones of the element sets in the second direction in plan view.

### BRIEF DESCRIPTION OF THE DRAWINGS

FIG. 1 is a conceptual diagram of a liquid crystal element according to a first embodiment of the present disclosure;

FIG. 2 is a plan view of the liquid crystal element according to the first embodiment of the present disclosure;

FIG. 3 is a sectional view of the liquid crystal element along line III-III illustrated in FIG. 2;

FIG. 4 is a plan view illustrating an arrangement of electric resistance films, first electrodes, and second electrodes;

FIG. 5 is a diagram illustrating the tilt degree of liquid crystal molecules when the liquid crystal element illustrated in FIG. 3 refracts emission light in a fourth direction;

FIG. 6 is a diagram illustrating the phase difference of emission light passing through a liquid crystal layer of the liquid crystal element illustrated in FIG. 5;

FIG. 7 is a sectional view of a liquid crystal element of a comparative example;

FIG. 8 is a diagram illustrating the tilt degree of liquid crystal molecules when the liquid crystal element of the comparative example illustrated in FIG. 7 refracts emission light in the fourth direction;

FIG. 9 is a sectional view of a liquid crystal element according to a first modification of the first embodiment of the present disclosure;

FIG. 10 is a plan view illustrating an arrangement of insulating members in a liquid crystal element according to a second modification of the first embodiment of the present disclosure;

FIG. 11 is a sectional view of a liquid crystal element according to a second embodiment of the present disclosure;

FIG. 12 is a plan view illustrating an arrangement of first electrodes and second electrodes included in the liquid crystal element illustrated in FIG. 11; and

FIG. 13 is a plan view illustrating an arrangement of second element sets illustrated in FIG. 11.

### DETAILED DESCRIPTION

Embodiments of the present disclosure will be described below with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

In this disclosure, when an element is described as being “on” another element, the element can be directly on the other element, or there can be one or more elements between the element and the other element.

A first direction D1 and a second direction D2 illustrated in the drawings correspond to directions parallel to the plate surfaces of substrates included in a liquid crystal element 1 to be described later. The first direction D1 and the second direction D2 correspond to directions along sides of the liquid crystal element 1. In the first direction D1, a side indicated by an arrow is a positive D1 side, and a side opposite to the positive D1 side is a negative D1 side. In the second direction D2, a side indicated by an arrow is a positive D2 side, and a side opposite to the positive D2 side is a negative D2 side.

A third direction D3 corresponds to the thickness direction of the liquid crystal element 1. In the third direction D3, a side indicated by an arrow is a positive D3 side, and a side opposite the positive D3 side is a negative D3 side. The positive D3 side in the third direction D3 corresponds to the front surface side of the liquid crystal element 1, and the negative D3 side in the third direction D3 corresponds to the back surface side of the liquid crystal element 1. In the present specification, “plan view” is the view when the liquid crystal element 1 is viewed in the third direction D3. The first direction D1, the second direction D2, and the third direction D3 are exemplary, and the present disclosure is not limited to these directions.

### First Embodiment

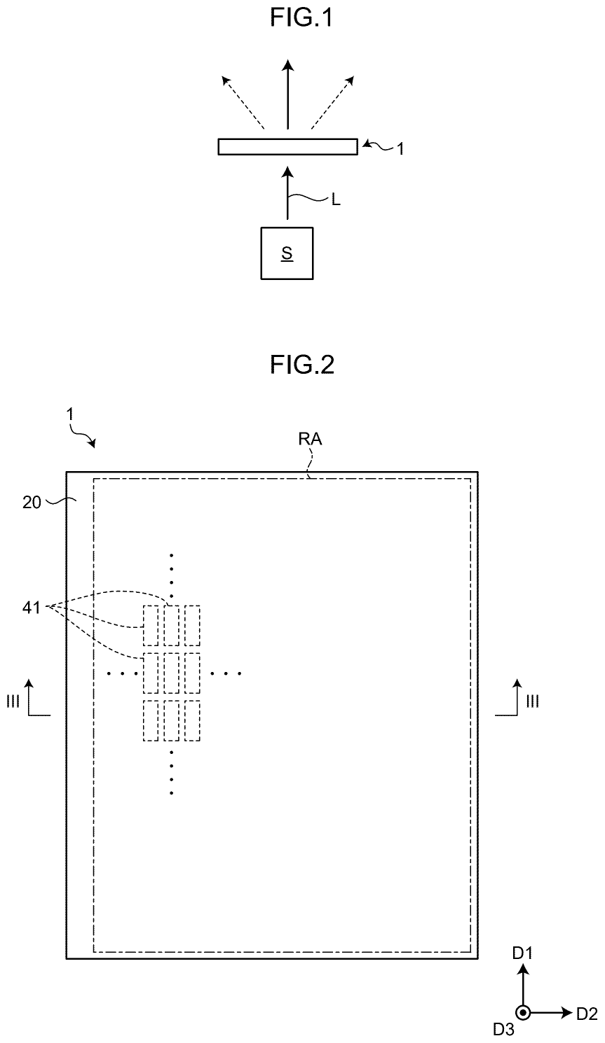

FIG. 1 is a conceptual diagram of the liquid crystal element 1 according to a first embodiment of the present disclosure. The liquid crystal element 1 is a refractive plate that refracts light. Emission light L emitted from a light source S enters the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows (to be described later in detail).

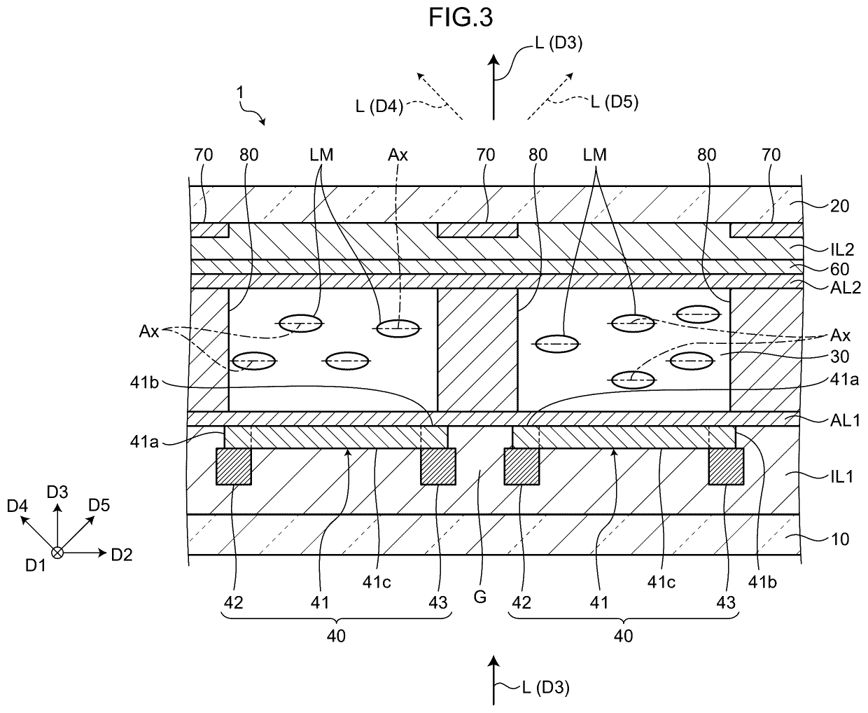

FIG. 2 is a plan view of the liquid crystal element 1 according to the first embodiment of the present disclosure. FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 along a plane orthogonal to the first direction D1.

The liquid crystal element 1 includes a first substrate 10, a second substrate 20, and a liquid crystal layer 30.

The first substrate 10 and the second substrate 20 face each other. The first substrate 10 and the second substrate 20 have a light-transmitting property. The first substrate 10 and the second substrate 20 are, for example, glass substrates, resin substrates, or resin films.

A plurality of element sets 40, a first insulating layer IL1, and a first alignment film AL1 are disposed on the first substrate 10. Each element set 40 includes an electric resistance film 41, a first electrode 42, and a second electrode 43.

As illustrated in FIG. 2, the electric resistance films 41 are arranged in a matrix having a row-column configuration in the first direction D1 and the second direction D2 in plan view. The electric resistance films 41 extend in the first direction D1 in plan view. Specifically, in plan view, the electric resistance films 41 each have a rectangular shape with the length in the first direction D1 longer than the length in the second direction D2. In plan view, the electric resistance films 41 overlap a refraction region RA that refracts the emission light L.

The electric resistance values of the electric resistance films 41 are larger than the electric resistance values of the first electrodes 42 and the second electrodes 43. The material of the electric resistance films 41 is a conductive material having a light-transmitting property, such as indium tin oxide (ITO), zinc oxide (ZnO), or indium gallium zinc oxide (IGZO).

As illustrated in FIG. 3, the first and second electrodes 42 and 43 are disposed on the back surface side of the electric resistance films 41.

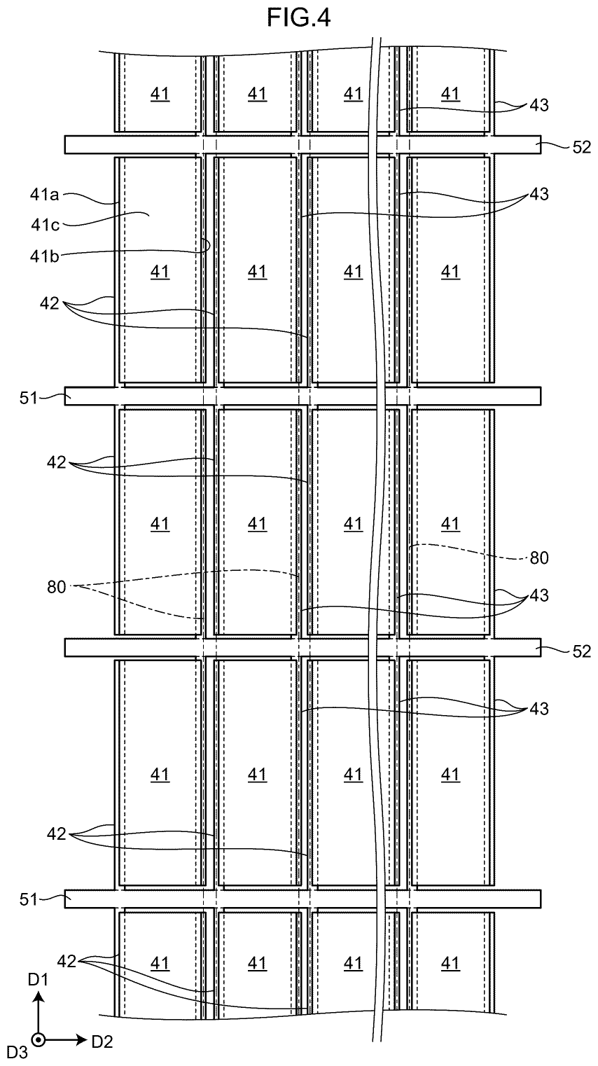

FIG. 4 is a plan view illustrating an arrangement of the electric resistance films 41, the first electrodes 42, and the second electrodes 43. The liquid crystal element 1 further includes a plurality of first trunk electrodes 51 and a plurality of second trunk electrodes 52 disposed on the first substrate 10.

The first trunk electrodes 51 extend in the second direction D2. The first trunk electrodes 51 are each positioned between two electric resistance films 41 adjacent to each other in the first direction D1. The first trunk electrodes 51 are separated from the electric resistance films 41 in plan view.

Each first trunk electrode 51 is electrically coupled to more than one of the first electrodes 42. The first trunk electrode 51 is integrated with the more than one of the first electrodes 42. The more than one of the first electrodes 42 are electrically coupled to the first trunk electrode 51 such that they protrude from the first trunk electrode 51 toward opposite sides in the first direction D1. The first electrodes 42 extend in the first direction D1. Each first electrode 42 electrically couples two electric resistance films 41 adjacent to each other with the first trunk electrode 51 interposed therebetween in the first direction D1.

As illustrated in FIGS. 3 and 4, the first electrodes 42 are arranged in the second direction D2 and each overlap an end part of an electric resistance film 41 on the negative D2 side in the second direction D2 in plan view and are each electrically coupled to the electric resistance film 41. The first electrode 42 is in contact with the electric resistance film 41.

The second trunk electrodes 52 extend in the second direction D2. The second trunk electrodes 52 are each positioned between two electric resistance films 41 adjacent to each other in the first direction D1. The second trunk electrodes 52 are separated from the electric resistance films 41 in plan view.

For each electric resistance film 41, the first trunk electrode 51 and the second trunk electrode 52 are disposed on opposite sides with the electric resistance film 41 interposed therebetween in the first direction D1. In other words, the first and second trunk electrodes 51 and 52 are alternately arranged in the first direction D1.

Each second trunk electrode 52 is electrically coupled to more than one of the second electrodes 43. The second trunk electrode 52 is integrated with the more than one of the second electrodes 43. The more than one of the second electrodes 43 are electrically coupled to the second trunk electrode 52 such that they protrude from the second trunk electrode 52 toward opposite sides in the first direction D1. The second electrodes 43 extend in the first direction D1. Each second electrode 43 electrically couples two electric resistance films 41 adjacent to each other with the second trunk electrode 52 interposed therebetween in the first direction D1.

As illustrated in FIGS. 3 and 4, a plurality of second electrodes 43 are arranged in the second direction D2 and each overlap an end part of an electric resistance film 41 on the positive D2 side in the second direction D2 in plan view and are electrically coupled to the electric resistance film 41. The second electrode 43 is in contact with the electric resistance film 41. In each element set 40, the first electrode 42 and the second electrode 43 are electrically coupled to the electric resistance film 41 in a state of facing each other in the second direction D2.

The length in the first direction D1 of a portion of the first electrode 42 electrically coupled to the end part of the electric resistance film 41 is equal to the length in the first direction D1 of a portion of the second electrode 43 electrically coupled to the electric resistance film 41. The sectional shape of the first electrode 42 is the same as the sectional shape of the second electrode 43. Accordingly, the length of the first electrode 42 in the second direction D2 is equal to the length of the second electrode 43 in the second direction D2.

As the electric resistance films 41, the first electrodes 42, and the second electrodes 43 are disposed in this manner, the element sets 40 are arranged in a matrix having a row-column configuration in the first direction D1 and the second direction D2.

The material of the first electrodes 42, the second electrodes 43, the first trunk electrodes 51, and the second trunk electrodes 52 is a conductive material such as molybdenum tungsten alloy (MoW) or TAT (Ti/Al/Ti) in which titanium (Ti) and aluminum (Al) are stacked. The material of the first electrodes 42, the second electrodes 43, the first trunk electrode 51, and the second trunk electrode 52 is a conductive material having a light-transmitting property, such as indium tin oxide (ITO), zinc oxide (ZnO), or indium gallium zinc oxide (IGZO).

The first and second trunk electrodes 51 and 52 are electrically coupled to a non-illustrated control circuit. The control circuit applies voltage to the first electrodes 42 through the first trunk electrodes 51. The control circuit applies voltage to the second electrodes 43 through the second trunk electrodes 52.

As illustrated in FIGS. 3 and 4, in the electric resistance film 41, a portion overlapping the first electrode 42 in plan view is a first overlap portion 41a, a portion overlapping the second electrode 43 in plan view is a second overlap portion 41b, and a portion between the first overlap portion 41a and the second overlap portion 41b is a middle portion 41c. In the second direction D2, the length of the middle portion 41c is longer than the sum of the length of the first overlap portion 41a and the length of the second overlap portion 41b.

In the first embodiment, in the second direction D2, the end of the first electrode 42 on the negative D2 side is positioned on the negative D2 side of the end of the electric resistance film 41 on the negative D2 side, and the end of the second electrode 43 on the positive D2 side is positioned on the positive D2 side of the end of the electric resistance film 41 on the positive D2 side. In the second direction D2, the end of the first electrode 42 on the negative D2 side may coincide with the end of the electric resistance film 41 on the negative D2 side, and the end of the second electrode 43 on the positive D2 side may coincide with the end of the electric resistance film 41 on the positive D2 side.

The first insulating layer IL1 illustrated in FIG. 3 electrically insulates the electric resistance films 41, the first trunk electrodes 51, and the second trunk electrodes 52 from one another. The first insulating layer IL1 also electrically insulates the first electrodes 42 and the second electrodes 43 from one another.

The first alignment film AL1 is disposed on the front surface side of the electric resistance film 41.

A third electrode 60, a second insulating layer IL2, a plurality of light-shielding films 70, and a second alignment film AL2 are disposed on the second substrate 20.

One third electrode 60 is disposed on the second substrate 20. The third electrode 60 overlaps the refraction region RA in plan view. The third electrode 60 overlaps the element sets 40 in plan view. The material of the third electrode 60 is a conductive material having a light-transmitting property, such as indium tin oxide (ITO), zinc oxide (ZnO), or indium gallium zinc oxide (IGZO).

The third electrode 60 is electrically coupled to a non-illustrated control circuit. The control circuit applies voltage to the third electrode 60.

The second insulating layer IL2 illustrated in FIG. 3 is disposed between the second substrate 20 and the third electrode 60. The second alignment film AL2 is disposed on the back surface side of the third electrode 60.

The light-shielding films 70 interrupt light transmission. The light-shielding films 70 have conductivity. The material of the light-shielding film 70 is, for example, molybdenum tungsten alloy (MoW). The light-shielding films 70 are disposed on the second substrate 20. The light-shielding films 70 are positioned between the second substrate 20 and the second insulating layer IL2. Each of the light-shielding films 70 overlap a gap G between two element sets 40 adjacent to each other in the second direction D2 in plan view.

The light-shielding films 70 each have a strip shape extending in the first direction D1. As illustrated in FIG. 3, the length of each element set 40 is longer than the length of each gap G in the second direction D2. In the first embodiment, the light-shielding films 70 overlap the first electrodes 42 and the second electrodes 43 in plan view. The light-shielding films 70 do not overlap the middle portions 41c in plan view.

The liquid crystal layer 30 is positioned between the first substrate 10 and the second substrate 20. The liquid crystal layer 30 is sandwiched between the first alignment film AL1 and the second alignment film AL2. The first alignment film AL1 and the second alignment film AL2 induce a predetermined alignment (initial orientation) of liquid crystal molecules LM contained in the liquid crystal layer 30 when no voltage is applied to the liquid crystal element 1. The initial orientation of the liquid crystal molecules LM is in such a direction (horizontal alignment) that a long axis Ax of each liquid crystal molecule LM is orthogonal to the third direction D3. The alignment direction of the first alignment film AL1 and the alignment direction of the second alignment film AL2 are parallel to each other in plan view.

The liquid crystal element 1 is an electrically controlled birefringence (ECB) liquid crystal element. However, the liquid crystal element 1 is not limited to an ECB liquid crystal element.

As illustrated in FIGS. 3 and 4, the liquid crystal element 1 further includes a plurality of insulating members 80 disposed in the liquid crystal layer 30. The insulating members 80 are illustrated with dashed and single-dotted lines in FIG. 4. The insulating members 80 overlap the light-shielding films 70 in plan view. The insulating members 80 have an electrical insulation property.

The insulating members 80 each have a strip shape extending in the first direction D1. Specifically, the insulating members 80 each have a strip shape extending in the first direction D1 from an end of the refraction region RA on the negative D1 side to an end thereof on the positive D1 side and are disposed so as to divide the liquid crystal layer 30 in plan view.

As illustrated in FIG. 3, each insulating member 80 overlaps the gap G between two adjacent ones of the element sets 40 in the second direction D2 in plan view. Accordingly, the insulating members 80 are arranged in the second direction D2. The insulating members 80 do not overlap the middle portions 41c in plan view.

In the third direction D3 (equivalent to “thickness direction of the liquid crystal layer 30”), the length of each insulating member 80 is equal to or longer than the length of the liquid crystal layer 30. Each insulating member 80 is disposed so as to be in contact with the first alignment film AL1 and the second alignment film AL2 and divide the liquid crystal layer 30 in the section illustrated in FIG. 3. Moreover, as described above, each insulating member 80 is disposed in the state of dividing the liquid crystal layer 30 in plan view. In other words, the insulating members 80 are disposed in the state of dividing the liquid crystal layer 30. Accordingly, adjacent regions of the liquid crystal layer 30 with an insulating member 80 interposed therebetween are not continuous but are separated from each other. The insulating members 80 have a light-transmitting property. The insulating members 80 may have a light-shielding property instead of a light-transmitting property.

The following describes operation when the liquid crystal element 1 refracts the emission light L from the light source S. Voltage is applied to the first electrodes 42, the second electrodes 43, and the third electrode 60 by a control circuit to refract the emission light L. The emission light L enters the liquid crystal element 1 in the third direction D3 from the back surface of the first substrate 10. A reference sign inside parentheses given to the emission light L indicates the direction in which the emission light L travels. In FIG. 3, the emission light L from the liquid crystal element 1 is illustrated on the positive D3 side of the liquid crystal element 1.

When no voltage is applied to the first electrodes 42, the second electrodes 43, and the third electrode 60, the alignment states of all liquid crystal molecules LM included in the liquid crystal layer 30 are in initial orientation (horizontal alignment) and all liquid crystal molecules LM have the same tilt degree. Thus, the phase change amount of the emission light L passing through the liquid crystal layer 30 is equal at all portions of the liquid crystal layer 30, and no phase difference occurs to the emission light L. Accordingly, the liquid crystal element 1 emits the emission light L without refraction. Specifically, as illustrated in FIG. 3, the liquid crystal element 1 causes the emission light L incident in the third direction D3 to exit therefrom in the third direction D3 without refraction.

When the liquid crystal element 1 refracts the emission light L from the light source S, voltage is applied to the first electrodes 42, the second electrodes 43, and the third electrode 60 such that the magnitude of a first potential difference between the potential of the first electrodes 42 and the potential of the third electrode 60 is different from the magnitude of a second potential difference between the potential of the second electrodes 43 and the potential of the third electrode 60. Hereinafter, the first electrodes 42, the second electrodes 43, and the third electrode 60 are simply referred to as “electrodes” when described without distinction.

Specifically, when the liquid crystal element 1 refracts the emission light L so that the light travels in a fourth direction D4 tilted to the negative D2 side relative to the third direction D3, voltage is applied to the electrodes such that the magnitude of the second potential difference is larger than the magnitude of the first potential difference.

In this case, from the first electrode 42 side toward the second electrode 43 side in the second direction D2, the potential of the electric resistance film 41 changes from the potential of the first electrode 42 to the potential of the second electrode 43 moves. Change in the potential of the electric resistance film 41 in the second direction D2 exhibits linearity.

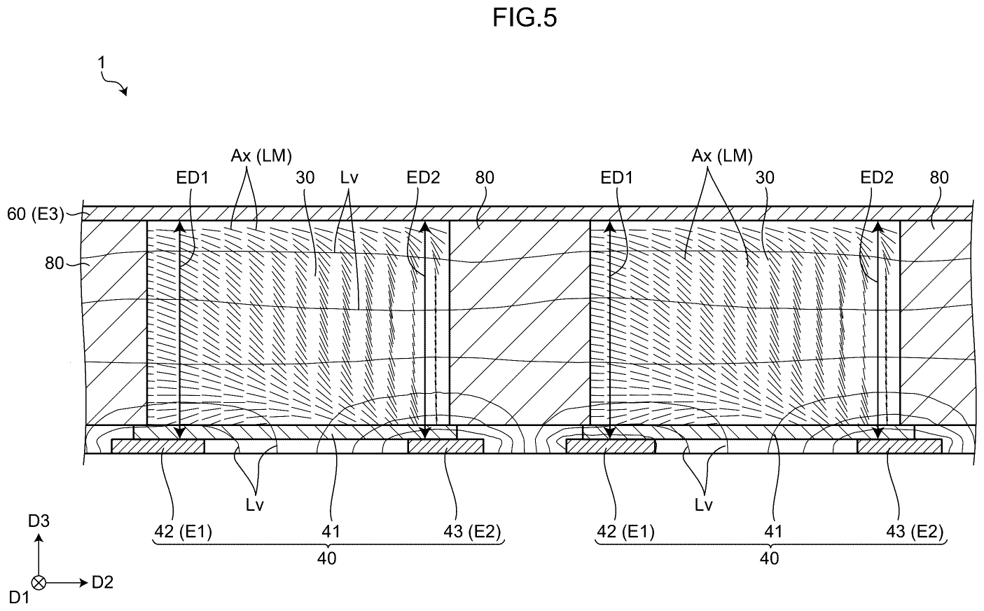

FIG. 5 is a diagram illustrating the tilt degree of the liquid crystal molecules LM when the liquid crystal element 1 illustrated in FIG. 3 refracts the emission light L in the fourth direction D4. In FIG. 5, the liquid crystal molecules LM are represented only by the long axes Ax of the liquid crystal molecules LM. Equipotential lines Lv of an electric field and the like generated in the liquid crystal layer 30 are illustrated in FIG. 5. The initial orientation of the liquid crystal molecules LM is horizontal alignment as described above. Accordingly, when no voltage is applied to the electrodes, the long axes Ax of the liquid crystal molecules LM align with the second direction D2.

When voltage is applied to the electrodes, the liquid crystal molecules LM are tilted by the electric field of the liquid crystal layer 30. As the magnitude of the potential difference in the third direction D3 increases in the liquid crystal layer 30, the tilt degree of the liquid crystal molecules LM increases (in other words, the angles of the long axes Ax of the liquid crystal molecules LM relative to the second direction D2 increase).

As the tilt degree of the liquid crystal molecules LM increases, the phase of the emission light L passing through the liquid crystal layer 30 advances. In other words, as the magnitude of the potential difference in the third direction D3 in the liquid crystal layer 30 increases, the phase of the emission light L advances.

FIG. 5 illustrates a state in which voltage is applied to the electrodes such that the magnitude (ED2) of the second potential difference between the second electrodes 43 and the third electrode 60 is larger than the magnitude (ED1) of the first potential difference between the first electrodes 42 and the third electrode 60 (ED1<ED2). Accordingly, in FIG. 5, the tilt degree of the liquid crystal molecules LM between the second and third electrodes 43 and 60 is larger than the tilt degree of the liquid crystal molecules LM between the first and third electrodes 42 and 60. From the first electrodes 42 toward the second electrodes 43 in the second direction D2, the magnitude of the potential difference in the third direction D3 and the tilt degree of the liquid crystal molecules LM increase.

In the state indicated in FIG. 5, voltage is applied to the electrodes such that the potential (E1) of the first electrodes 42 is larger than the potential (E2) of the second electrodes 43 (E2<E1) and the potential (E1) of the first electrodes 42 is equal to the potential (E3) of the third electrode 60 (E1=E3).

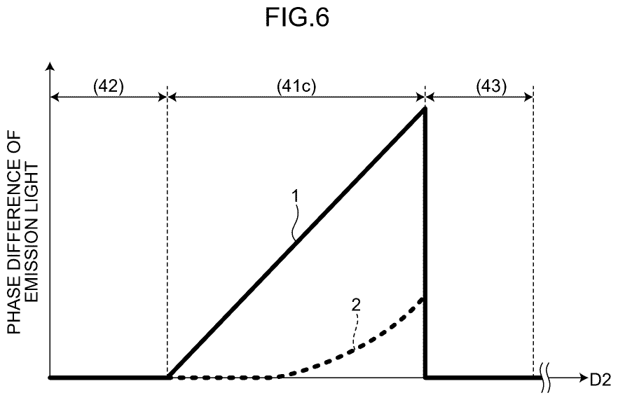

FIG. 6 is a diagram illustrating the phase difference of the emission light L passing through the liquid crystal layer 30 of the liquid crystal element 1 illustrated in FIG. 5. The vertical axis in FIG. 6 represents the phase difference of the emission light L. The horizontal axis in FIG. 6 represents the position in the second direction D2 in the liquid crystal layer 30. In FIG. 6, the region of “(42)” represents the region of a first electrode 42 in the second direction D2, the region of “(43)” represents the region of a second electrode 43 in the second direction D2, and the region of “(41c)” represents the region of a middle portion 41c in the second direction D2. FIG. 6 illustrates, with a solid line, the phase difference of the emission light L passing through the liquid crystal layer 30 when the phase of the emission light L passing between the first electrode 42 and the corresponding third electrode 60 is regarded as a reference (zero).

Since the magnitude of the second potential difference is larger than the magnitude of the first potential difference (ED1<ED2) as described above, the phase difference of the emission light L increases from the negative D2 side toward the positive D2 side in the second direction D2 between the first electrode 42 and the second electrode 43, as illustrated in FIG. 6. In other words, the phase of the emission light L passing through the liquid crystal layer 30 advances from the negative D2 side toward the positive D2 side in the second direction D2 between the first electrode 42 and the second electrode 43. Accordingly, the emission light L is refracted to be emitted in the fourth direction D4. As described above, change in the potential of the electric resistance films 41 in the second direction D2 exhibits linearity. Accordingly, change in the phase difference of the emission light L in the second direction D2 exhibits linearity.

In a case where the liquid crystal element 1 refracts the emission light L to travel in a fifth direction D5 tilted to the positive D2 side relative to the third direction D3, voltage is applied to the electrodes such that the magnitude of the first potential difference is larger than the magnitude of the second potential difference (ED2<ED1). For example, voltage is applied to the electrodes such that the potential (E2) of the second electrodes 43 is larger than the potential (E1) of the first electrodes 42 (E1<E2) and the potential (E2) of the second electrodes 43 is equal to the potential (E3) of the third electrode 60 (E2=E3).

Since the magnitude of the first potential difference is larger than the magnitude of the second potential difference (ED2<ED1), the phase difference of the emission light L increases from the positive D2 side toward the negative D2 side in the second direction D2 between the first electrode 42 and the second electrode 43. In other words, the phase of the emission light L passing through the liquid crystal layer 30 advances from the positive D2 side toward the negative D2 side in the second direction D2 between the first electrode 42 and the second electrode 43. Accordingly, the emission light L is refracted to be emitted in the fifth direction D5.

In this manner, the liquid crystal element 1 can easily adjust the emission direction of the emission light L by controlling voltage applied to the electrodes.

The following describes the configuration of a liquid crystal element 2 of a comparative example.

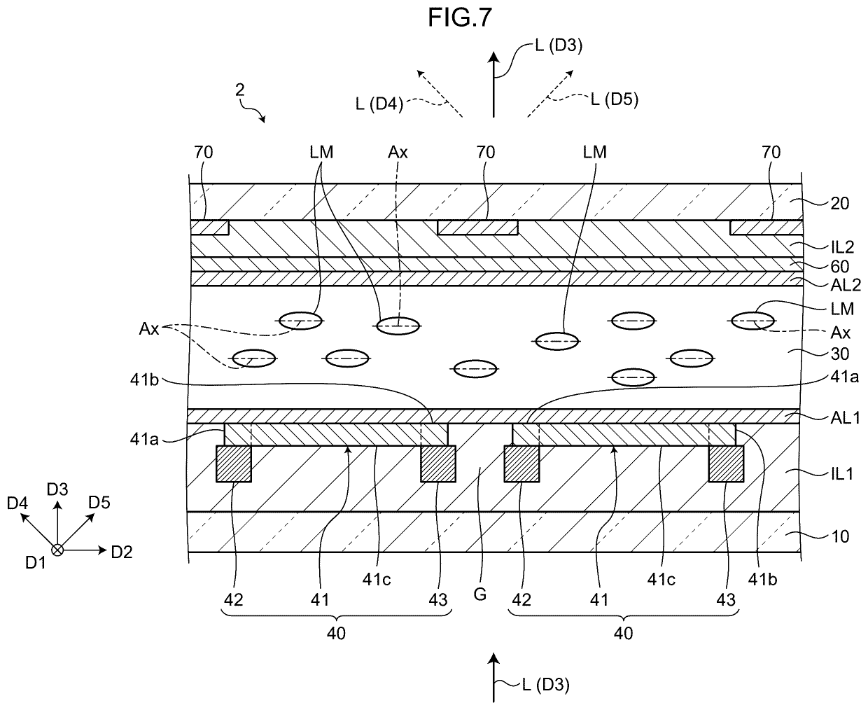

FIG. 7 is a sectional view of the liquid crystal element 2 of the comparative example. The liquid crystal element 2 of the comparative example does not include the insulating members 80 unlike the above-described liquid crystal element 1. Accordingly, in the liquid crystal element 2 of the comparative example, the liquid crystal layer 30 is not divided but is continuous.

When the liquid crystal element 2 of the comparative example refracts the emission light L from the light source S, as in the above-described liquid crystal element 1, voltage is applied to the first electrodes 42, the second electrodes 43, and the third electrode 60 such that the magnitude of the first potential difference between the potential of the first electrodes 42 and the potential of the third electrode 60 is different from the magnitude of the second potential difference between the potential of the second electrodes 43 and the potential of the third electrode 60.

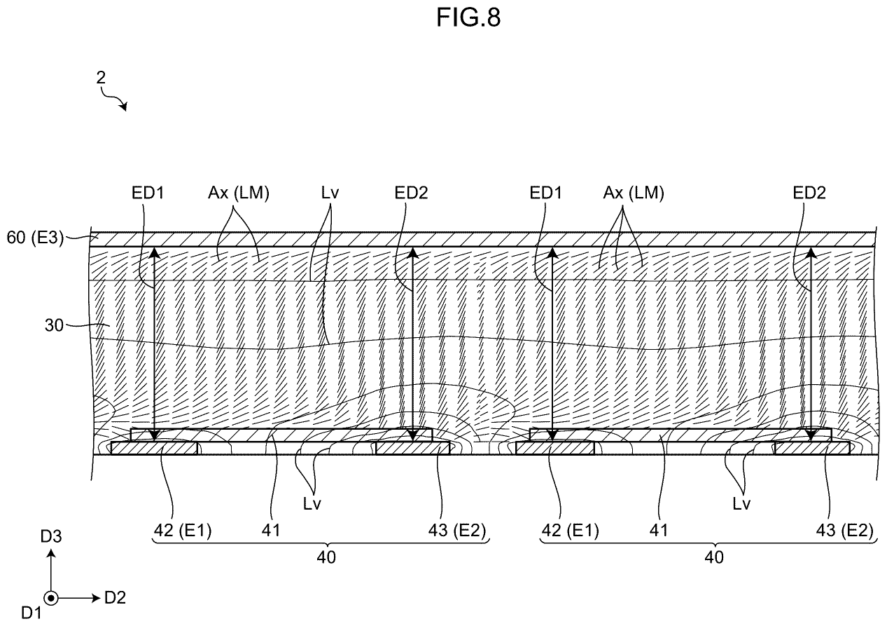

FIG. 8 is a diagram illustrating the tilt degree of the liquid crystal molecules LM when the liquid crystal element 2 of the comparative example illustrated in FIG. 7 refracts the emission light L in the fourth direction D4.

The potentials of the electrodes in the liquid crystal element 2 of the comparative example illustrated in FIG. 8 are equal to the potentials of the electrodes in the liquid crystal element 1 illustrated in FIG. 5.

The following describes comparison between the liquid crystal element 2 of the comparative example illustrated in FIG. 8 and the liquid crystal element 1 illustrated in FIG. 5. In the liquid crystal element 2 of the comparative example illustrated in FIG. 8, the liquid crystal layer 30 is continuous as described above. Accordingly, the tilt degree of the liquid crystal molecules LM continuously changes across the entire liquid crystal layer 30. In other words, the tilt degree of the liquid crystal molecules LM in the liquid crystal layer 30 overlapping the element sets 40 in plan view is affected by the liquid crystal molecules LM in the liquid crystal layer 30 corresponding to the gap G between two adjacent ones of the element sets 40 in the second direction D2.

However, in the liquid crystal element 1 illustrated in FIG. 5, the liquid crystal layer 30 is divided by the insulating members 80 as described above. In this case, the tilt degree of the liquid crystal molecules LM in one of two regions of the liquid crystal layer 30, corresponding to two adjacent ones of the element sets 40 with an insulating member 80 interposed therebetween, is not affected by the other region, and the tilt degree of the liquid crystal molecules LM in the other region is not affected by the one region. Thus, for example, the tilt degree of the liquid crystal molecules LM between each first electrode 42 and the third electrode 60 is smaller in the liquid crystal element 1 illustrated in FIG. 5 than in the liquid crystal element 2 of the comparative example illustrated in FIG. 8. Accordingly, difference in the tilt degree of the liquid crystal molecules LM between the first electrode 42 and the second electrode 43 in the second direction D2 is larger in the liquid crystal element 1 illustrated in FIG. 5 than in the liquid crystal element 2 of the comparative example illustrated in FIG. 8.

As a result, as illustrated in FIG. 6, the phase difference of the emission light L in the liquid crystal element 1, which is illustrated with the solid line, is larger than the phase difference of the emission light L in the liquid crystal element 2 of the comparative example, which is illustrated with the dashed line. In other words, in the liquid crystal element 1, the refraction angle of the emission light L can be increased since the insulating members 80 are provided, as compared to the liquid crystal element 2 of the comparative example. A part where the phase difference of the emission light L in the liquid crystal element 2 of the comparative example coincides with the phase difference of the emission light L in the liquid crystal element 1 is illustrated with a solid line.

Moreover, in the liquid crystal element 1, the phase difference of the emission light L can be generated from the first electrode 42 to the second electrode 43 in the second direction D2, as compared to the liquid crystal element 2 of the comparative example. In other words, in the liquid crystal element 1, the emission light L can be refracted in a desired direction, as compared to the liquid crystal element 2 of the comparative example.

### Modifications of First Embodiment

The following describes modifications of the first embodiment of the present disclosure with focus on difference from the liquid crystal element 1 of the above-described first embodiment.

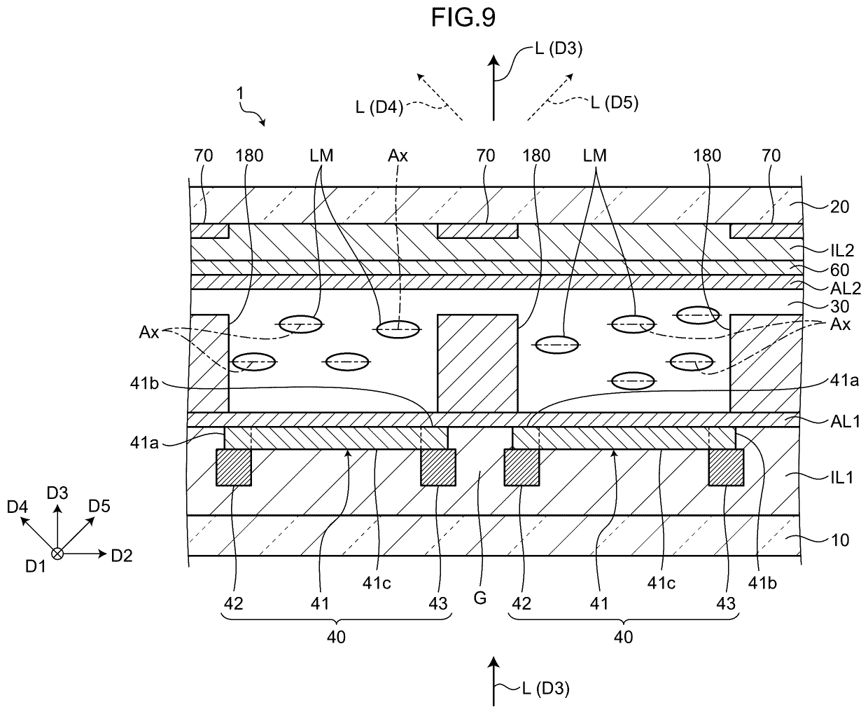

FIG. 9 is a sectional view of the liquid crystal element 1 according to a first modification of the first embodiment of the present disclosure. In the first modification, in the third direction D3 (in other words, thickness direction of the liquid crystal layer 30), the length of each insulating member 180 is shorter than the length of the liquid crystal layer 30. The insulating members 180 are in contact with the first alignment film AL1. In other words, the insulating members 180 are spaced apart from the second alignment film AL2.

Accordingly, in the first modification, the liquid crystal layer 30 is continuous on the positive D3 side of the insulating members 180. In this case, as compared to the liquid crystal element 1 of the above-described first embodiment, liquid crystal can be easily distributed between the first substrate 10 and the second substrate 20 during the manufacturing process of the liquid crystal element 1. Thus, in the liquid crystal element 1 of the first modification, it is possible to simplify the manufacturing process of the liquid crystal layer 30 and reduce influence on the tilt degree of the liquid crystal molecules LM between two regions of the liquid crystal layer 30 corresponding to two adjacent ones of the element sets 40 in the second direction D2. The insulating members 80 may be in contact with the second alignment film AL2 and spaced apart from the first alignment film AL1.

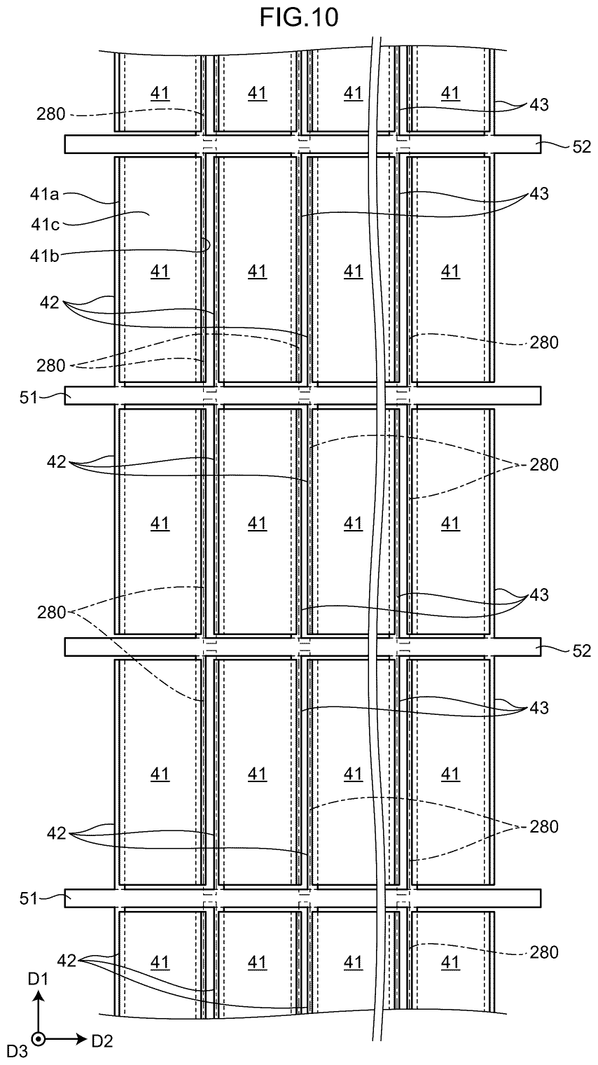

FIG. 10 is a plan view illustrating an arrangement of insulating members 280 in the liquid crystal element 1 according to a second modification of the first embodiment of the present disclosure.

In the second modification, a plurality of insulating members 280 are disposed in the first direction D1. Two adjacent ones of the insulating members 280 in the first direction D1 are spaced apart from each other. In other words, in the second modification, the liquid crystal layer 30 is continuous between two adjacent ones of the insulating members 280 in the first direction D1. Thus, in the second modification, as in the above-described first modification, it is possible to simplify the manufacturing process of the liquid crystal layer 30 and reduce influence on the tilt degree of the liquid crystal molecules LM between two regions of the liquid crystal layer 30 corresponding to two adjacent ones of the element sets 40 in the second direction D2.

In the above-described first embodiment and modifications of the first embodiment, each element set 40 may include no electric resistance film 41.

### Second Embodiment

The following describes the liquid crystal element 1 according to a second embodiment of the present disclosure with focus on difference from the liquid crystal element 1 of the above-described first embodiment.

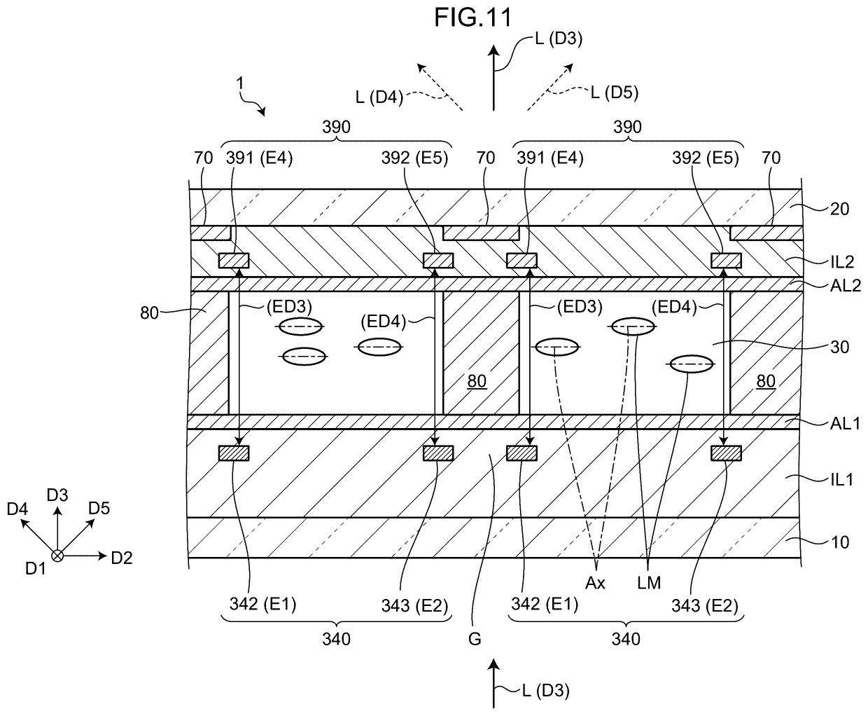

FIG. 11 is a sectional view of the liquid crystal element 1 according to the second embodiment of the present disclosure. The liquid crystal element 1 of the second embodiment includes no third electrode 60. Moreover, each element set 340 in the liquid crystal element 1 of the second embodiment includes no electric resistance film 41.

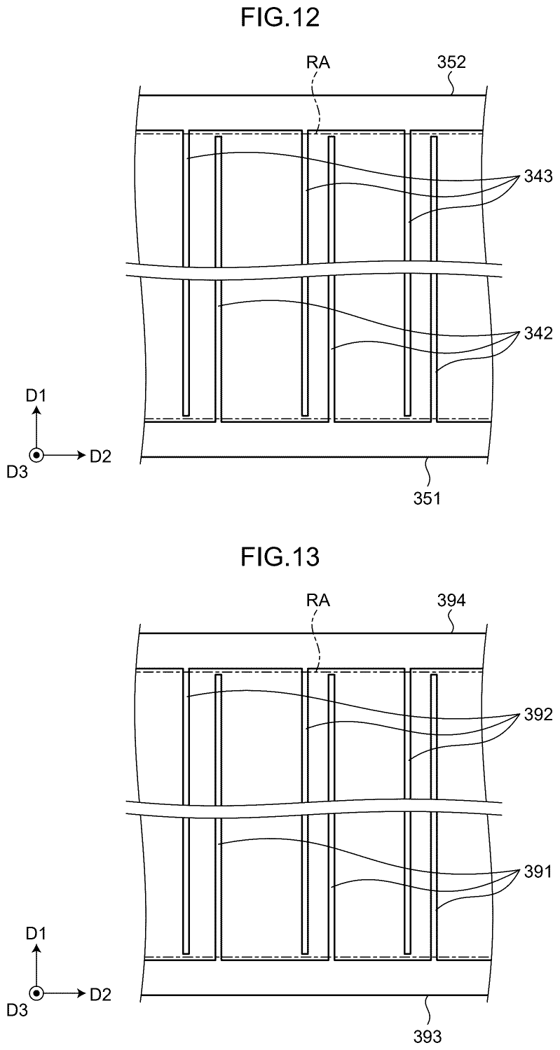

FIG. 12 is a plan view illustrating an arrangement of first electrodes 342 and second electrodes 343 included in the liquid crystal element 1 illustrated in FIG. 11.

As illustrated in FIG. 12, the first electrodes 342 and the second electrodes 343 extend in the first direction D1 from the end of the refraction region RA on the negative D1 side to the end thereof on the positive D1 side. In addition, a first trunk electrode 351 is disposed to extend in the second direction D2 on the outer side (negative D1 side) of the refraction region RA and electrically coupled to the first electrodes 342. A second trunk electrode 352 is disposed to extend in the second direction D2 on the outer side (positive D1 side) of the refraction region RA and electrically coupled to the second electrodes 343.

As illustrated in FIG. 11, the liquid crystal element 1 of the second embodiment further includes a plurality of second element sets 390. The second element sets 390 each include a fourth electrode 391 and a fifth electrode 392.

FIG. 13 is a plan view illustrating an arrangement of the second element sets 390 illustrated in FIG. 11. As illustrated in FIG. 13, the fourth electrodes 391 and the fifth electrodes 392 extend in the first direction D1 from the end of the refraction region RA on the negative D1 side to the end thereof on the positive D1 side.

As illustrated in FIGS. 11 and 13, in one second element set 390, the fourth electrode 391 and the fifth electrode 392 face each other in the second direction D2. In the second direction D2, the length of the first electrode 342, the length of the second electrode 343, the length of the fourth electrode 391, and the length of the fifth electrode 392 are equal to one another.

In each of the second element sets 390, the fourth electrode 391 overlaps the first electrode 342 of one of the element sets 340 in plan view, and the fifth electrode 392 overlaps the second electrode 343 of the one element set 340 in plan view. The element sets 340 and the second element sets 390 are arranged in the second direction D2.

As illustrated in FIG. 13, the liquid crystal element 1 of the second embodiment further includes a third trunk electrode 393 and a fourth trunk electrode 394.

The third trunk electrode 393 is disposed on the outer side (negative D1 side) of the refraction region RA to extend in the second direction D2 and electrically coupled to the fourth electrodes 391. The third trunk electrode 393 is integrated with the fourth electrodes 391. The third trunk electrode 393 is electrically insulated from the fifth electrodes 392.

The fourth trunk electrode 394 is disposed on the outer side (positive D1 side) of the refraction region RA to extend in the second direction D2 and electrically coupled to the fifth electrodes 392. The fourth trunk electrode 394 is integrated with the fifth electrodes 392. The fourth trunk electrode 394 is electrically insulated from the fourth electrodes 391.

The third and fourth trunk electrodes 393 and 394 are electrically coupled to a control circuit. The control circuit applies voltage to the fourth electrodes 391 through the third trunk electrode 393. The control circuit applies voltage to the fifth electrodes 392 through the fourth trunk electrode 394.

The material of the fourth electrodes 391, the fifth electrodes 392, the third trunk electrode 393, and the fourth trunk electrode 394 is a conductive material such as molybdenum tungsten alloy (MoW) or TAT (Ti/Al/Ti) in which titanium (Ti) and aluminum (Al) are stacked. The material of the fourth electrodes 391, the fifth electrodes 392, the third trunk electrode 393, and the fourth trunk electrode 394 may be a conductive material having a light-transmitting property, such as indium tin oxide (ITO), zinc oxide (ZnO), or indium gallium zinc oxide (IGZO).

The second insulating layer IL2 electrically insulates the fourth electrodes 391 and the fifth electrodes 392 from each other. The second insulating layer IL2 also electrically insulates the third trunk electrode 393 and the fourth trunk electrode 394 from each other.

The second alignment film AL2 is disposed on the negative D3 side of the fourth electrodes 391 and the fifth electrodes 392. The second alignment film AL2 is disposed in a state of being separated from the fourth electrodes 391 and the fifth electrodes 392. The second alignment film AL2 may be in contact with the fourth electrodes 391 and the fifth electrodes 392.

The following describes operation when the liquid crystal element 1 of the second embodiment refracts the emission light L from the light source S. The liquid crystal element 1 refracts the emission light L when voltage is applied to the first electrodes 342, the second electrodes 343, the fourth electrodes 391, and the fifth electrodes 392 by a control circuit.

When no voltage is applied to the first electrodes 342, the second electrodes 343, the fourth electrodes 391, and the fifth electrodes 392, the alignment states of all liquid crystal molecules LM included in the liquid crystal layer 30 are in initial orientation (horizontal alignment), and all liquid crystal molecules LM have the same tilt degree. In this case, the liquid crystal element 1 emits the emission light L without refraction.

When the liquid crystal element 1 refracts the emission light L from the light source S, voltage is applied to the first electrodes 342, the second electrodes 343, the fourth electrodes 391, and the fifth electrodes 392 such that the magnitude (ED3) of a third potential difference between the potential (E1) of the first electrodes 342 and the potential (E4) of the fourth electrodes 391 is different from the magnitude (ED4) of a fourth potential difference between the potential (E2) of the second electrodes 343 and the potential (E5) of the fifth electrodes 392.

When the liquid crystal element 1 refracts the emission light L so that the light travels in the fourth direction D4, voltage is applied to the electrodes such that the magnitude of the fourth potential difference is larger than the magnitude of the third potential difference (ED3<ED4).

In this case, the tilt degree of the liquid crystal molecules LM between the second and fifth electrodes 343 and 392 is larger than the tilt degree of the liquid crystal molecules LM between the first and fourth electrodes 342 and 391. Moreover, the magnitude of the potential difference in the third direction D3 and the tilt degree of the liquid crystal molecules LM increase from the negative D2 side toward the positive D2 side in the second direction D2 between the first and second electrodes 42 and 43.

Accordingly, the phase of the emission light L passing through the liquid crystal layer 30 advances from the negative D2 side toward the positive D2 side in the second direction D2 between the first and second electrodes 42 and 43. As a result, the emission light L is refracted to be emitted in the fourth direction D4.

When the liquid crystal element 1 refracts the emission light L so that the light travels in the fifth direction D5, voltage is applied to the electrodes such that the magnitude (ED3) of the third potential difference is larger than the magnitude (ED4) of the fourth potential difference (ED4<ED3).

Accordingly, the phase of the emission light L passing through the liquid crystal layer 30 advances from the positive D2 side toward the negative D2 side in the second direction D2 between the second and first electrodes 43 and 42. Thus, the emission light L is refracted to be emitted in the fifth direction D5.

### Modifications of Second Embodiment

The following describes modifications of the second embodiment of the present disclosure with focus on difference from the liquid crystal element 1 of the above-described second embodiment.

In the liquid crystal element 1 of the second embodiment, each element set 340 may further include an electric resistance film 41 as in the liquid crystal element 1 of the above-described first embodiment. In this case, the electric resistance film 41 may have a strip shape extending in the first direction D1 from the end of the refraction region RA on the negative D1 side to the end thereof on the positive D1 side.

In the liquid crystal element 1 of the second embodiment, in the third direction D3, the length of each insulating member 80 may be shorter than the length of the liquid crystal layer 30 as in the liquid crystal element 1 of the first modification of the above-described first embodiment. Moreover, a plurality of insulating members 80 may be disposed in the first direction D1.

### Other Modifications

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the light-shielding film 70 may be disposed on the first substrate 10. The liquid crystal element 1 does not necessarily need to include the light-shielding films 70.

The electric resistance films 41 may be electrically coupled to the first electrodes 42 and the second electrodes 43 in a state of being separated from the first electrodes 42 and the second electrodes 43.

The first alignment film AL1 and the second alignment film AL2 may have a gap between two adjacent ones of the element sets 40 in plan view. In this case, the insulating members 80 may be in contact with the first insulating layer IL1 and the second insulating layer IL2. Moreover, in this case, the insulating members 80 may be in contact with the electric resistance films 41.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate and a second substrate facing each other;
a plurality of element sets disposed on the first substrate and each including a first electrode and a second electrode;
a third electrode disposed on the second substrate and overlapping the element sets in plan view;
a liquid crystal layer positioned between the first substrate and the second substrate; and
an insulating member having an electrical insulation property and disposed in the liquid crystal layer, wherein
in plan view, the first electrode and the second electrode in each of the element sets extend in a first direction and face each other in a second direction orthogonal to the first direction,
the element sets are arranged in the second direction, and
the insulating member overlaps a gap between two adjacent ones of the element sets in the second direction in plan view.

2. The liquid crystal element according to claim 1, wherein in a thickness direction of the liquid crystal layer, the length of the insulating member is shorter than the length of the liquid crystal layer.

3. The liquid crystal element according to claim 1, wherein
a plurality of the insulating members are disposed in the first direction, and
two adjacent ones of the insulating members in the first direction are spaced apart from each other.

4. The liquid crystal element according to claim 1, wherein each of the element sets further includes an electric resistance film extending in the first direction and electrically coupling the first electrode and the second electrode.

5. The liquid crystal element according to claim 1, further comprising a light-shielding film disposed on one of the first substrate and the second substrate and overlapping a gap between two adjacent ones of the element sets in the second direction in plan view.

6. A liquid crystal element comprising:
a first substrate and a second substrate facing each other;
a plurality of element sets disposed on the first substrate and each including a first electrode and a second electrode;
a plurality of second element sets disposed on the second substrate and each including a fourth electrode and a fifth electrode;
a liquid crystal layer positioned between the first substrate and the second substrate; and
an insulating member having an electrical insulation property and disposed in the liquid crystal layer, wherein
in plan view, the first electrode and the second electrode in each of the element sets extend in a first direction and face each other in a second direction orthogonal to the first direction,
in each of the second element sets,
the fourth electrode extends in the first direction and overlaps the first electrode of one of the element sets in plan view, and
the fifth electrode extends in the first direction and overlaps the second electrode of the one element set in plan view,
the element sets and the second element sets are each arranged in the second direction, and
the insulating member overlaps a gap between two adjacent ones of the element sets in the second direction in plan view.
